(19) United States
(12) Patent Application Publication
(10) Pub. No.: US 2009/0095541 A1
(43) Pub. Date: Apr. 16, 2009

(54) INPUT DEVICE

(75) Inventor: Bang-Won Lee, Gyeonggi-do (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/297,391

(22) PCT Filed: Apr. 6, 2007
(86) PCT No.: PCT/KR2007/001692

§ 371 Date: Oct. 16, 2008

(30) Foreign Application Priority Data
May 8, 2006 (KR) 10-2006-0041153

(51) Int. Cl. G06F 3/041

(52) U.S. Cl. 178/18.03

(57) ABSTRACT

Provided is an input device. The input device includes: n first input lines; m groups of n second input lines connected to the n first input lines in different manners, wherein m is larger than n; an input unit having m groups of n touch units correspondingly connected to the m groups of n second input lines; and an input signal determination part for decoding signals from the n first input lines to generate input signals. Therefore, the input device can generate a large number of input signals through a small number of input lines using an electrical touch sensor having a single pressure pad for detecting a contact. In addition, partially using a pressure sensor instead of the touch sensor, it is possible to generate a larger number of input signals.

### TECHNICAL FIELD

The present invention relates to an input device, and more particularly, to an input device capable of generating a large number of input signals through a small number of input lines.

### BACKGROUND ART

In modern times, most people in the world use numerous electronic appliances, for example, home appliances such as television sets, radios and washing machines, information devices such as computers and mobile phones, and various amusement machines such as game players, MP3 devices and so on.

Such electronic appliances determine a user interface on the basis of each use and function from initial design of products. The user interface enables a user to input an order to an electronic appliance. Since operational convenience of the electronic appliance can be determined depending on constitution of the user interface, the constitution of the user interface is very important to a user. Even though function of the electronic appliance may be excellent, if it is difficult for a user to operate the electronic appliance, such a product may not be selected by consumers. Therefore, a manufacturer of the electronic appliances must design a user interface such that a user can conveniently operate the user interface.

Another consideration in design of the user interface is rapid miniaturization of the electronic appliances. With miniaturization of the electronic appliances, various kinds of multi-functional devices, rather than a single-function device, have come into the market.

Miniaturization of the electronic appliances narrows a space in which input means such as buttons and input pads for transmitting orders of a user can be disposed, and various functions of the product increase the number of input orders which makes it difficult to constitute the user interface of the electronic appliance. Recently, in order to solve this problem, a mobile device employs buttons and pads for performing different functions when the buttons or pads are pushed for a short time or a long time. In addition, with miniaturization of the electronic appliances, layout of internal components of the product should be constituted in a minimized area using necessary interconnections.

Still another consideration in design of the user interface is exterior design. With increase of interest in the exterior design due to high standards of living of users, high quality exterior design has become as important as some aspects of interior design, as well as functions of the electronic appliances. Therefore, the exterior design for the user interface should also be considered.

As a result, a touch sensor or a touch screen is widely used as input means of the user interface, instead of the conventional buttons. The touch sensor has advantages of rapid operation speed and excellent compact design, and the touch screen has an advantage of removing separate input means.

As described above, the user interface should be designed as an essential part of the design of electronic appliances. Even though the user interface is designed with such a consideration in mind, the user interface may be modified due to a design error, requirements according to a user's preference, addition of a new function, and so on. When the user interface is modified, reduction in the number of input means almost not happens. Even though reduction in the number of input means happens, there is no problem since the previous layout can be maintained. However, in general cases, modification of the user interface causes addition of the input means according to addition of functions. Adding the input means to the user interface, since the external parts such as buttons and layout of internal input lines should be modified, is a time and cost consuming problem. At worst, no input means can be added due to lack of a space for modifying the layout.

FIGS. 1 and 2 are views showing examples of a conventional user interface including touch sensors as input means.

Each of the touch sensors includes an input pad in contact with an object, and a touch detection part for determining whether the input pad is in contact with a certain object.

The user interface in FIG. 1 includes input pads PAD11 and PAD12 connected to two pairs of input lines line1, line2, line3 and line4 to receive input signals, respectively. Each of the input pads PAD11 and PAD12 is formed of a pair of touch pads. When a conductive object is in contact with the two touch pads, the touch pads are electrically connected to each other. When any one of the input pads PAD11 and PAD12 is electrically connected, the touch detection part (not shown) installed in an input signal determination part 10 generates a touch signal corresponding thereto. The input signal determination part 10 recognizes a touch signal output from the touch detection part to determine the selected input pads PAD11 and PAD12 to output an input signal corresponding thereto.

The user interface in FIG. 1 may generate two input signals, and when an additional input signal is required, a constitution shown in FIG. 2 may be used. The interface in FIG. 2 includes three pairs of first input lines line1, line2, line3, line4, line 5 and line6, and three pairs of input pads PAD21, PAD22 and PAD23 to receive three input signals. An input signal determination part 11 receives input signals from the six first input lines line1, line2, line3, line4, line 5 and line6 to determine the corresponding orders. In addition, when four input signals are required, an additional input pad and input line pair should be added. That is, in order to add input signals, the same number of input pad and input line pairs should be added, and therefore the layout should be modified.

### DISCLOSURE

### Technical Problem

In order to solve the foregoing and/or other problems, it is an aspect of the present invention to provide an input device capable of generating a large number of input signals through a small number of input lines.

### Technical Solution

One aspect of the present invention provides an input device including: n first input lines; m groups of n second input lines connected to the n first input lines in different manners, wherein m is larger than n; input means having m groups of n touch means correspondingly connected to the m groups of n second input lines; and an input signal determination part for decoding signals forms the n first input lines to generate input signals.

In the input means, m and n may satisfy the following relationship:

m≦2ⁿ−1.

The second input lines may be connected to the m groups of n touch means to connect the first input lines to the touch means corresponding to digits, in which 1 of each of binary numbers from 1 to 2ⁿ−1 is disposed.

The input signal determination part may include n touch detection parts connected to the n first input lines, respectively, for detecting whether a user applies an input to the input means, and a decoding part for decoding touch signals output from the n touch detection parts to output a plurality of input signals.

The touch detection part may detect a change in capacitance caused by the touch object, even though a touch is generated at one touch means, and output a touch signal.

Another aspect of the present invention provides an input device including: n first input lines; m groups of n second input lines connected to the n first input lines in different manners, wherein m is larger than n; at least one third input line; at least one fourth input lines connected to the at least one third input lines; first input means having m groups of n touch means correspondingly connected to the m groups of n second input lines; second input means having pressure means correspondingly connected to the at least one fourth input lines; and an input signal determination part for decoding signals from the n first input lines to generate a first input signal and generating a second signal corresponding to the at least one third input lines.

The second input means may include at least one pressure means for varying impedance when a pressure is applied.

The input signal determination part may include n touch detection parts connected to the n first input lines to detect whether a user applies an input to the input means, respectively; at least one pressure detection part connected to the third input lines to detect whether a user applied an input to the pressure means; and a decoding part for decoding touch signals output from the n touch detection parts to output a first input signal, and decoding pressure data output from the at least one pressure detection part to output a second input signal.

The pressure detection part may detect a change in impedance generated when a pressure is applied to the at least one pressure means and output pressure data.

The input device may further include a controller for setting a mode in response to the first input signal to output a mode signal, and performing a predetermined operation designated according to the set mode when the second input signal is applied; and a display part for displaying the current mode in response to the mode signal, and displaying an indication corresponding to the second input signal.

The input device may further include a controller for setting a mode in response to the first input signal to output a mode signal, and performing a predetermined operation according to the set mode when the second input signal is applied; and a touch screen for displaying the current mode and an input key corresponding to the current mode in response to the mode signal, and for generating an input signal to output the input signal to the controller when a user's input is received.

The input device may further include a controller for setting a mode in response to the second input signal to output a mode signal, and performing a predetermined operation designated according to the set mode when the first input signal is applied; and a display part for displaying the current mode in response to the mode signal, and displaying an indication corresponding to the first input signal.

The input device may further include a controller for setting a mode in response to the second input signal to output a mode signal, and performing a predetermined operation according to the set mode when the first input signal is applied; and a touch screen for displaying the current mode and an input key corresponding to the current mode in response to the mode signal, and for generating an input signal to output the input signal to the controller when a user's input is received.

### DESCRIPTION OF DRAWINGS

These and/or other aspects and advantages of the present invention will become apparent and more readily appreciated from the following description of exemplary embodiments of the invention, taken in conjunction with the accompanying drawings of which:

FIGS. 1 and 2 are views showing examples of a conventional user interface including touch sensors as input means;

FIG. 3 is a view showing an electrical touch sensor of a conventional user interface having a single input pad;

FIGS. 4 and 5 are views of an input device in accordance with an exemplary embodiment of the present invention;

FIGS. 6 and 7 are views of the input pad shown in FIGS. 4 and 5;

FIG. 8 is a view of an input signal determination part shown in FIGS. 4 and 5;

FIG. 9 is a view of an input device in accordance with another exemplary embodiment of the present invention;

FIG. 10 is a view of an input device in accordance with still another exemplary embodiment of the present invention;

FIG. 11 is a view of a pressure sensor having a single pressure pad as shown in FIGS. 4 and 5;

FIG. 12 is a view of an input device having a touch sensor and a pressure sensor in accordance with the present invention; and

FIGS. 13, 14 and 15 are views of an electronic appliance having an input device using the pressure pad shown in FIG. 12.

### MODES OF THE INVENTION

Exemplary embodiments of the present invention will now be described in detail with reference to the accompanying drawings, throughout which like reference numerals refer to like elements.

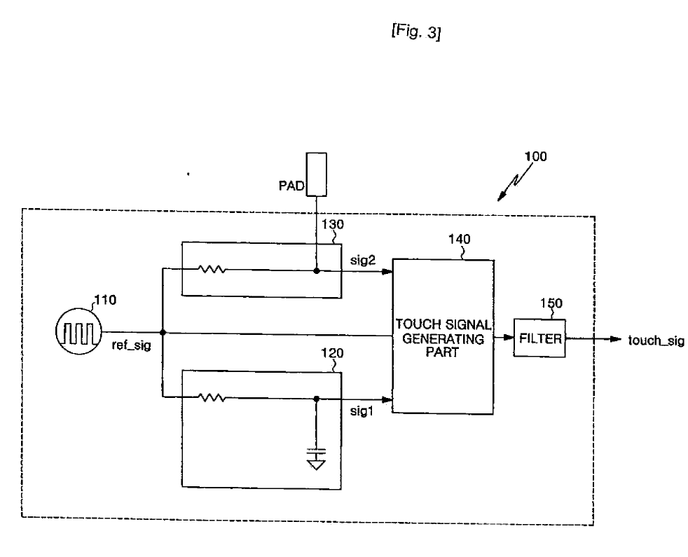

FIG. 3 is a view showing an electrical touch sensor having a single input pad, which is disclosed in Korean Patent No. 10-0666699, filed on Mar. 21, 2005.

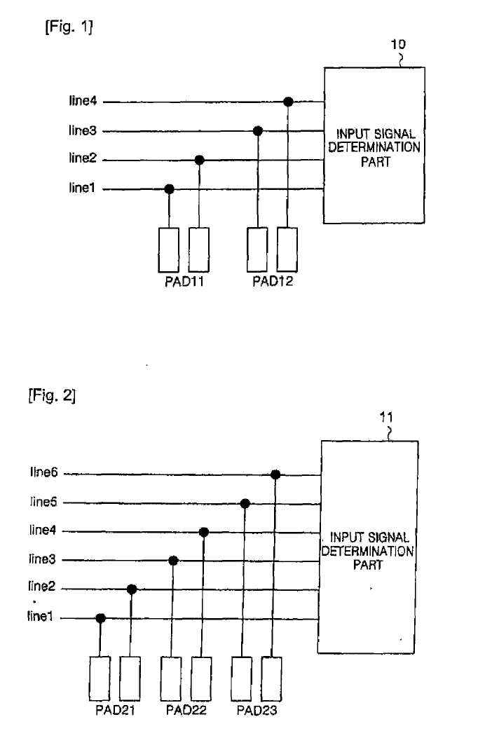

The electrical touch sensor shown in FIG. 3 includes a single touch pad PAD and a touch detection part 100, different from a touch sensor shown in FIGS. 1 and 2. The touch detection part 100 includes a reference signal generating part 110, a first signal generating part 120, a second signal generating part 130, a touch signal generating part 140, and a filter 150.

The reference signal generating part 110 generates a reference signal ref_sig.

The first signal generating part 120 delays the reference signal ref_sig to generate a first signal sig1.

The second signal generating part 130 is connected to the touch pad PAD to delay the reference signal ref_sig to generate a second signal sig2 delayed less than the first signal sig1 when there is no contact with the touch pad PAD, and to delay the reference signal ref_sig to generate a second signal sig2 delayed more than the first signal sig1 when there is a contact with the touch pad PAD.

The touch signal generating part 140 is synchronized by the first signal sig1 to receive the second signal sig2, and generates a touch signal touch_sig to determine a contact with the touch pad PAD to output the contact. The touch signal generating part may be implemented using a D flip-flop. That is, the first signal sig1 is applied as a clock signal of the D flip-flop, and the second signal sig2 is applied as a data signal of the D flip-flop. The D filp-flop is synchronized with a falling edge of the first signal sig1 to latch the second signal sig2, thereby generating a touch signal touch_sig. The filter 150 stabilizes and smoothes a touch signal touch_sig, and then outputs the touch signal touch_sig to the exterior.

The filter 150 removes noise, which may be generated when a touch signal touch_sig is generated from the touch signal generating part 140.

The touch sensor shown in FIG. 3 includes a single touch pad PAD, and detects a contact using capacitance of a touch object to output a touch signal touch_sig. That is, it is possible to detect a contact using capacitance, not conductivity, and adjust a waveform of a reference signal ref_sig, or adjust sensitivity of the touch sensor by adjusting a delay time of the first signal generating part 120.

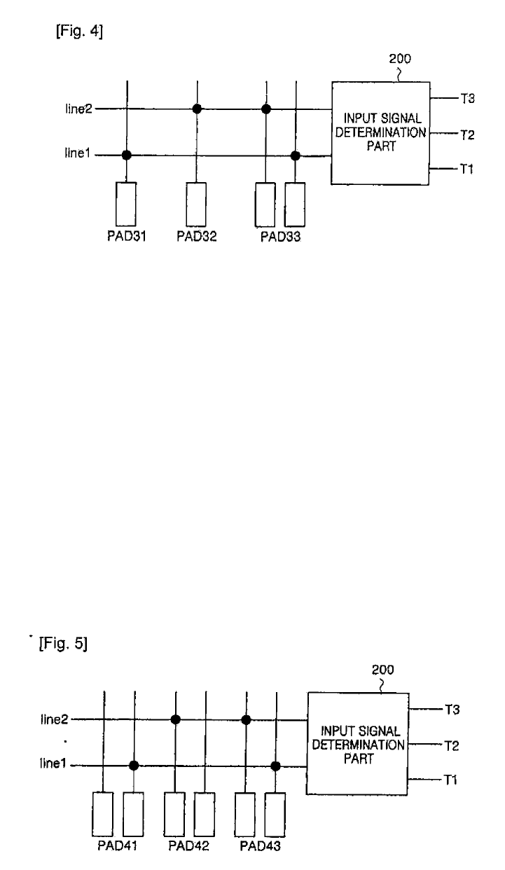

FIGS. 4 and 5 are views of an input device in accordance with an exemplary embodiment of the present invention.

Referring to FIGS. 4 and 5, the touch sensor shown in FIG. 3 is used as input means. Here, each line in FIGS. 4 and 5 is corresponding to the touch pad PAD in FIG. 3. Therefore, the input device may include two first input lines line1 and line2 for receiving two input signals. Being different from FIGS. 1 and 2, the input device in FIGS. 4 and 5 is enlarged to receive three input signals using two first input lines line1 and line2.

Since it is possible to detect a contact using a single pad as shown in FIG. 4, each of input pads PAD31 and PAD32 includes a touch pad, and the two touch pads are connected to first input lines line1 and line2, respectively. The input pad PAD33 includes two touch pads, and the two touch pads are connected to the two first input lines line1 and line2, respectively.

An input signal determination part 200 includes the same number of the touch detection part 100 shown in FIG. 3 as the number of first input lines line1 and line2 to detect whether an object is in contact with the input pads PAD31, PAD32 and PAD33, thereby generating a touch signal. In addition, the input signal determination part 200 decodes the generated touch signal to output three input signals T1, T2 and T3.

When the input signal determination part 200 is constituted of the touch sensor shown in FIG. 3, three pads PAD31, PAD32 and PAD33 may be connected to the two input lines line1 and line2 to output three input signals.

That is, when a user selects the first input pad PAD31, the input signal determination part 200 detects a contact through the first input line line1 to output the input signal T1. When the second input pad PAD32 is selected, the input signal determination art 200 detects a contact through the first input line line2 to output the input signal T2. When the third input pad PAD33 is selected, the input signal determination part 200 detects a contact through the two first input lines line1 and line2 to output the input signal T3.

FIG. 5 is a view showing a method of receiving three input signals through the two first input lines line1 and line2, similar to FIG. 4. In FIG. 5, each of input pads PAD41, PAD42 and PAD43 include two touch pads PAD, similar to the input pad PAD33 shown in FIG. 4. In addition, the input signal determination part 200 has the same constitution as in FIG. 4.

As shown in FIG. 5, each of the input pads PAD41, PAD42 and PAD43 has a pair of touch pads to provide an advantage of readily maintaining symmetry and improve constitutional stability, in comparison with the input pad having a separate touch sensor like PAD31 and PAD32. In addition, since the touch detection part of the input signal determination part 200 detects capacitance of a touch object in contact with the input pads PAD41, PAD42 and PAD43, when the input pads PAD41, PAD42 and PAD43 are formed as the same shape, the input pads PAD41, PAD42 and PAD43 have the same contact area with the touch object so that a difference between variations of the impedance detected by the touch detection part through the first input lines line1 and line2 is small. Therefore, even though any one of the input pads PAD41, PAD42 and PAD43 is selected, since the touch detection part detects substantially the same level of impedance variation, sensitivity of the touch detection part can be readily set.

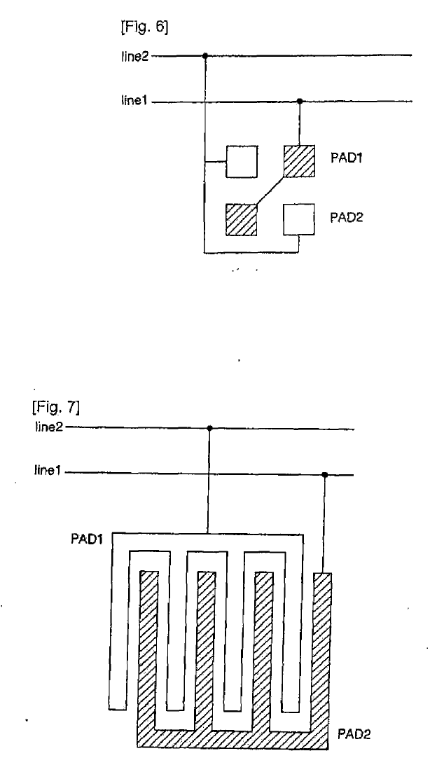

FIGS. 6 and 7 are views of the input pads PAD33, PAD41, PAD42 and PAD43 shown in FIGS. 4 and 5.

The input pad must recognize a contact whenever a touch object is in contact with the touch pad. However, when each of the input pads PAD33, PAD41, PAD42 and PAD43 shown in FIGS. 4 and 5 has two touch pads and the touch pads are separately disposed, even though a user selects the input pads PAD33, PAD41, PAD42 and PAD43, the two touch pads may not be simultaneously in contact with the user. When using the conventional touch sensor, since the touch sensor cannot detect a contact when only one of the two touch pads is in contact with an object, there is no input signal. On the other hand, in the case of the two input pads PAD33 and PAD 43 connected to the two first input lines line1 and line2 among the input pads PAD33, PAD41, PAD42 and PAD43 shown in FIGS. 4 and 5, the input signal determination part 200 determines that another input pad PAD31, PAD32, PAD41 or PAD42 is selected, thereby generating an input signal T1 or T2. When such an incorrect input signal T1 or T2 is generated, the input device malfunctions. The malfunction of the input device may cause a worse result than failure of the input device. For example, a storage device may malfunction to delete important data, thereby decreasing reliability of the product.

Therefore, two touch pads PAD1 and PAD2 shown in FIGS. 6 and 7 have an arrangement in which the two touch pads can be in contact with an object.

The two touch pads PAD1 and PAD2 shown in FIG. 6 have each pair of pads arranged in a diagonal direction to cross each other. The first touch pad PAD1 has a pair of pads disposed at a right upper corner and a left lower corner, and the second touch pad PAD2 has a pair of pads disposed at a left upper corner and a right lower corner. In addition, the first touch pad PAD1 is connected to the first input line line1, and the second touch pad PAD2 is connected to the first input line line2.

The touch pads PAD1 and PAD2 shown in FIG. 6 cause the two pads to be simultaneously in contact with a touch object having a predetermined size to prevent an incorrect input signal from being generated. If a touch object is too small to be in contact with a portion of the divided touch pads PAD1 and PAD2, the divided touch pads PAD1 and PAD2 are further divided (for example, into eight pads) such that the touch object must be in contact with the two touch pads PAD1 and PAD2.

The touch pads PAD1 and PAD2 shown in FIG. 7 have complex patterns inserted into each other in an alternate manner, rather than dividing the touch pad PAD1 or PAD2 such that a touch object must be in contact with the two touch pads PAD1 and PAD2.

The touch pads PAD1 and PAD2 shown in FIGS. 6 and 7, which are also used in a conventional art, may be formed in various manners. While FIGS. 6 and 7 illustrate the input pad having two touch pads PAD1 and PAD2, more touch pads may be arranged in this manner.

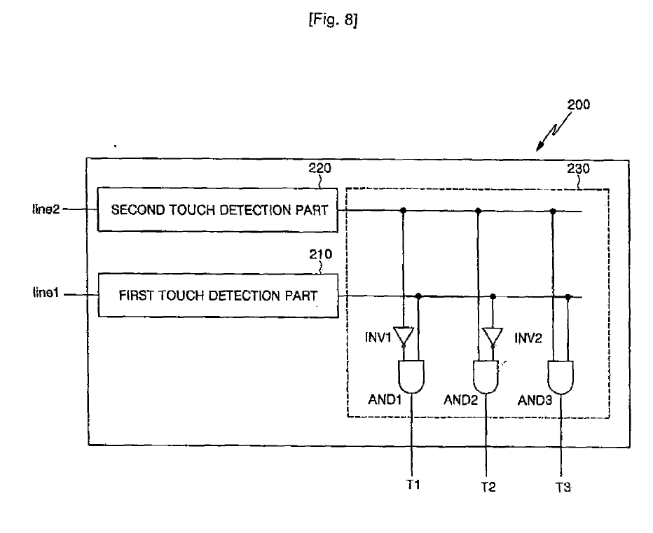

FIG. 8 is a view of the input signal determination part 200 shown in FIGS. 4 and 5.

The input signal determination part 200 includes first and second touch detection parts 210 and 220 connected to the first input lines line1 and line2 and detecting whether a touch object is in contact with the input pad to output a touch signal, and a decoding part 230 for decoding the touch signal applied from the first and second touch detection parts 210 and 220 to output input signals T1, T2 and T3.

The first and second touch detection parts 210 and 220 correspond to the touch detection part 100 of FIG. 3, and are connected to the two first input line line1 and line2, respectively. Similar to FIG. 3, each of the touch detection parts 210 and 220 includes a reference signal generating part 110, a first signal generating part 120, a second signal generating part 130, a touch signal generating part 140, and a filter 150. It is natural that the reference signal generation part 110 can be shared and the first signal generation part 120 can be shared.

The first touch detection part 210 generates a touch signal when an object having a predetermined capacitance is in contact with the input pads PAD31, PAD33, PAD41 and PAD43 connected to the first input line line1, and the second touch detection part 220 generates a touch signal when an object having a predetermined capacitance is in contact with the input pads PAD32, PAD33, PAD42 and PAD43 connected to the first input line line2.

The decoding part 230 includes three AND gate AND1, AND2 and AND3 and two inverters INV1 and INV2 for decoding a touch signal output from the first and second touch detection parts 210 and 220. The decoding part 230 outputs an input signal T1 when a touch signal is applied from only the first touch detection part 210, outputs an input signal T2 when a touch signal is applied from only the second touch detection part 220, and outputs an input signal T3 when touch signals are applied from both the first and second touch detection parts 210 and 220.

Therefore, when a user selects one input pad from the input pads PAD31, PAD32, PAD33, PAD41, PAD42 and PAD43 shown in FIGS. 4 and 5, the input signal determination part 200 outputs one input signal from three input signals T1, T2 and T3 through the two first input lines line1 and line2.

For example, when the input pad PAD41 shown in FIG. 5 is in contact with an object, an impedance of the first input line line1 is varied due to capacitance of the contacted object. Since the first input line line2 is not connected to the input pad PAD41, there is no variation in impedance.

The first touch detection part 210 of the input signal determination part 200 detects a change in the impedance of the first input line line1 to generate a touch signal, and the second touch detection part 220 does not generate a touch signal since there is no a change in the impedance of the first input line line2.

The decoding part 230 outputs the input signal T1 since the first touch detection part 210 generates a touch signal and the second touch detection part 220 does not generate a touch signal. Similarly, when a contact is generated at the input pad PAD42, the input signal T2 is output, and when a contact is generated at the input pad PAD43, the input signal T3 is output.

As described above, FIGS. 4 and 5 show a method of detecting three input signals using two first input lines line1 and line2.

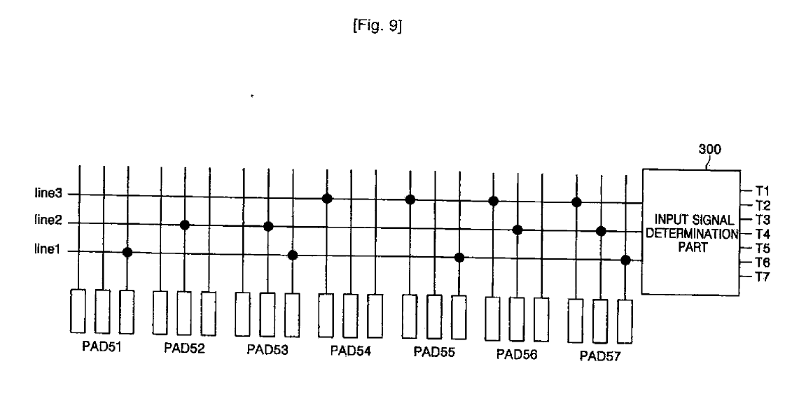

FIG. 9 is a view of an input device in accordance with another exemplary embodiment of the present invention.

FIG. 9 shows a method of detecting an input signal when three input lines exist. The input device includes three first input lines line1, line2 and line3, seven input pads PAD51 to PAD57, each of which has three touch pads, seven second input lines, each of which has three input lines, and an input signal determination part 300.

The input pad PAD51 is connected to only the first input line line1, the input pad PAD52 is connected to only the first input line line2, the input pad PAD53 is connected to the two first input lines line1 and line2, the input pad PAD57 is connected to the three first input lines line1, line2 and line3. The above connection has the same disposition in which a binary number having three digits ascends from “001” to “111”. That is, each digit corresponds to each input line, “0” means that the input line is not connected, and “1” means that the input line is connected. However, there is no connection corresponding to the binary number “000”. The binary number “000” means that the first input lines line1, line2 and line3 are not connected to the input pads, i.e., there is no connection between the first input lines and the input pads. Therefore, when the first input lines line1, line2 and line3 are three, the input pad may have 7 input pads PAD51 to PAD57, according to a formula 2ⁿ−1, wherein n=3.

While the input signal determination part 300 has substantially the same constitution as FIG. 8, each of the first input lines line1, line2 and line3 must have a touch detection part, and thus three touch detection parts are required. And a decoding part also a additional composition is necessary.

As shown in FIG. 9, it is possible to maximally output seven input signals T1 to T7 using three first input lines line1, line2 and line3.

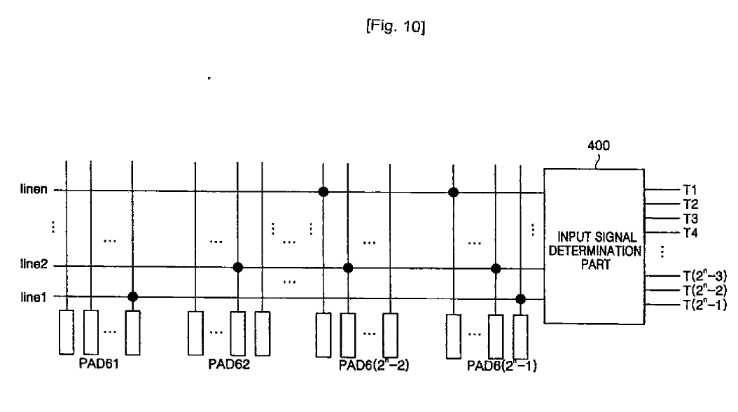

FIG. 10 shows the case that the input device has n first input lines line1 to linen.

In the case of n first input lines line1 to linen, the maximum number of input pads for detecting input signals through touches is 2ⁿ−1, and therefore, input signals T1−T2ⁿ−1 can be output.

Specifically, as shown in FIG. 10, the input device in accordance with the present invention can generate a large number of input signals through a small number of input lines to detect input signals in substantial proportion to 2, wherein n is the number of input lines. However, when the number of input lines is n, each of the input pads PAD61 to PAD6 (2ⁿ−1) must have n touch pads, and the number of second input lines must also be n. In this case, as shown in FIGS. 6 and 7, it is very difficult to form a pattern such that all touch pads are simultaneously in contact with an object. Therefore, the touch pads should be arranged such that all touch pads of the input pad can be in contact with an object. If possible, it is desirable to prevent touch pads of which number exceeds two from becoming simultaneously in contact with an object.

Table 1 represents an example in which input signals are preferably used when four first input lines are provided.

TABLE 1

| | | | | Input | Use it |
|---|---|---|---|---|---|
| Line1 | Line2 | Line3 | Line4 | signal | or not |
| 0 | 0 | 0 | 1 | T1 | ◯ |
| 0 | 0 | 1 | 0 | T2 | ◯ |
| 0 | 0 | 1 | 1 | T3 | ◯ |
| 0 | 1 | 0 | 0 | T4 | ◯ |
| 0 | 1 | 0 | 1 | T5 | ◯ |
| 0 | 1 | 1 | 0 | T6 | ◯ |
| 0 | 1 | 1 | 1 | T7 | X |
| 1 | 0 | 0 | 0 | T8 | ◯ |
| 1 | 0 | 0 | 1 | T9 | ◯ |
| 1 | 0 | 1 | 0 | T10 | ◯ |
| 1 | 0 | 1 | 1 | T11 | X |
| 1 | 1 | 0 | 0 | F12 | ◯ |
| 1 | 1 | 0 | 1 | T13 | X |
| 1 | 1 | 1 | 0 | T14 | X |
| 1 | 1 | 1 | 1 | T15 | X |

As can be seen from Table 1, in the case of four first input lines, the maximum number of input pads may be fifteen, and the maximum number of input signals may be fifteen. Since the number of first input lines is four, each of the input pads must have four touch pads. However, when the number of touch pads which should be simultaneously in contact with an object is large, it is difficult to form a pattern of the touch pad and make the object simultaneously in contact with all the touch pads. Therefore, in Table 1, input signals T7, T11, T13, T14 and T15, in which at least three touch pads should be in contact with the object, may not be used. Excluding the cases in which at least three touch pads should be in contact with the object, each of the input pads corresponding to the used input signals T1 to T6, T8 to T10, and T12 may be disposed to include two touch pads. For example, the input pad corresponding to the input signal T6 has two touch pads, and each touch pad is connected to only two first input lines line2 and line3. Similarly, another input pad has two touch pads, and each touch pad is connected to the corresponding first input lines line1 to line4.

Even though the input pads are disposed to receive a touch signal from only the input pads having two touch pads, the maximum number of input signals T1 to T6, T8 to T10, and T12 generated through the four first input lines line1 to line4 is ten. Similarly, when the input pads are disposed to receive touch signals from only the input pads having two touch pads through n first input lines line1 to linen, the number of input signals is the sum of connections in which only one touch pad is connected to the n first input lines line1 to linen, i.e., n, and connections in which two touch pads are connected to the n first input lines line1 to linen, i.e., nX(n−1)/2. For example, when the number of first input lines is six, the maximum number of input signals may be 6+(6×5)/2=21.

The above input device generates a large number of touch signals through a small number of input lines using a touch sensor for detecting a contact using a single touch pad, and decodes the generated touch signal, thereby generating the large number of input signals.

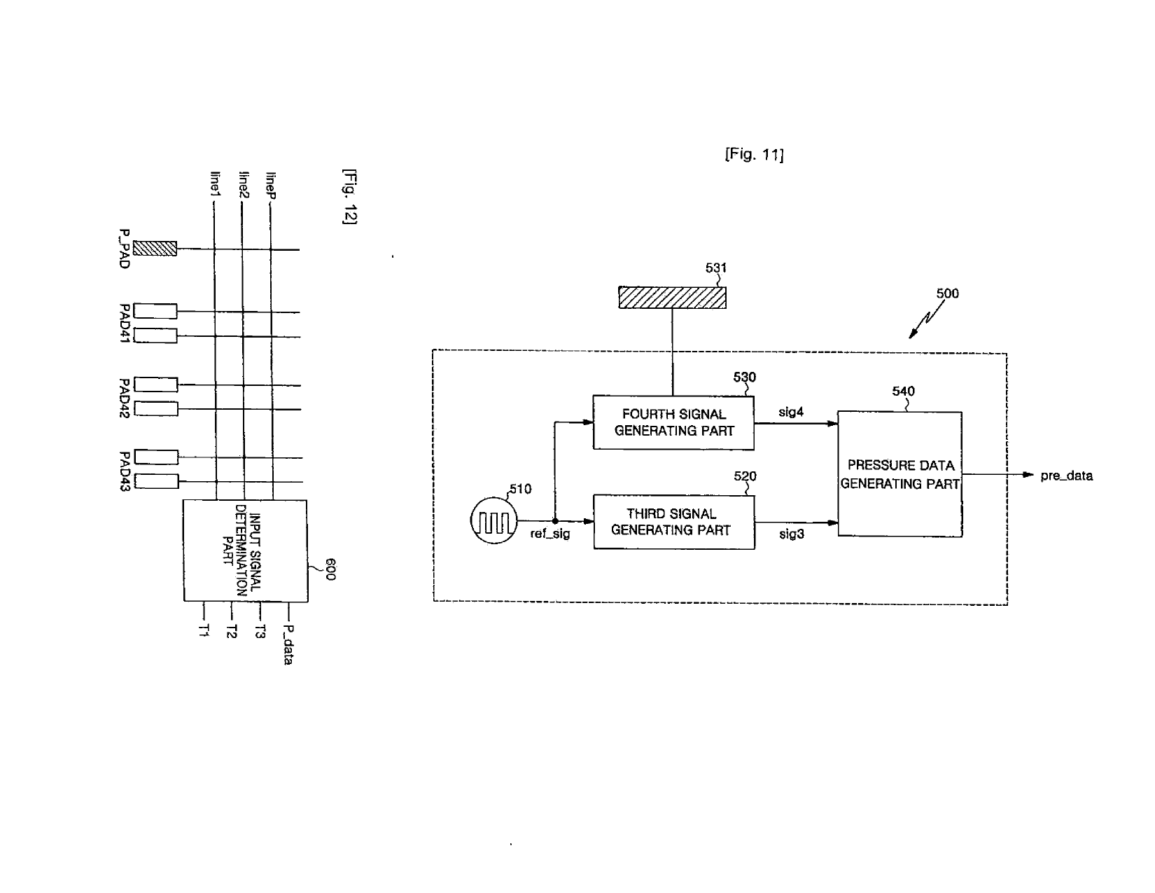

FIG. 11 is a view of a pressure sensor having a single pressure pad, similar to the touch sensor shown in FIG. 3, which is disclosed in Korean Patent Application No. 2005-114414, filed on Nov. 28, 2005.

The pressure sensor shown in FIG. 11 includes a pressure pad 531 and a pressure detection part 500.

Describing the pressure sensor in FIG. 11 with reference to FIG. 3, a reference signal generating part 510 generates a reference signal ref_sig, similar to the reference signal generating part 110 of FIG. 3.

The pressure pad 531 may employ all kinds of devices in which impedance is varied in response to a pressure applied from the exterior.

A fourth signal generating part 530 variably delays a reference signal ref_sig depending on a change in impedance of the pressure pad 531 to output a fourth signal sig4. The fourth signal sig4 has a short delay time when a pressure is not applied to the pressure pad 531, and a long delay time when a large pressure is applied.

Since a third signal generating part 520 generates a third signal sig3 having the same delay time as the time that the reference signal ref_sig is delayed at the fourth signal generating part 530 when a pressure is not applied to the pressure pad 531, the third signal generating part 520 has an impedance value equal to the sum of an impedance value of the pressure pad 531 when a pressure is not applied and an impedance value of the fourth signal generating part 530.

At this time, a variable impedance value may be capacitance, resistance, or inductance. However, constitution of the third signal generating part 520 and the fourth signal generating part 530 is determined according to the variable impedance.

That is, when the variable impedance is capacitance, the fourth signal generating part 530 includes a resistor for generating an RC delay to a reference signal ref_sig, similar to the second signal generating part of FIG. 3, and the third signal generating part 520 includes a capacitor connected to a resistor and a ground voltage, similar to the first signal generating part 120 of FIG. 3.

In this process, the third signal generating part 520 is configured to have the same delay time of the third signal sig3 as the fourth signal sig4 generated from the fourth signal generating part 530 when a pressure is not applied to the pressure pad. For example, the resistor of the third signal generating part 520 has the same resistance as the resistor of the fourth signal generating part 530, and the capacitor of the third signal generating part 520 has the same capacitance as when a pressure is not applied to the pressure pad 531.

Similarly, when the resistance is varied as an impedance value of the pressure pad 531, the fourth signal generating part 530 includes the capacitor connected to the ground voltage, and the third signal generating part 520 includes the capacitor having the same capacitance as the capacitor of the fourth signal generating part 530 and the resistor having the same resistance as when a pressure is not applied to the pressure pad 531.

In addition, when the inductance is varied as an impedance value of the pressure pad 531, the fourth signal generating part 530 includes the resistor connected to the ground voltage, and the third signal generating part includes the resistor having the same resistance as the resistor of the fourth signal generating part 530, and a reactance having the same inductance as when a pressure is not applied to the pressure pad 531.

A pressure data generating part 540 measures a difference between the delay times of the third signal sig3 and the fourth signal sig4 to output a value corresponding to the measured delay time difference as pressure data pre_data. When a pressure is not applied to the pressure pad 531, since the third signal sig3 has the same delay time as the fourth signal sig4, the pressure data pre_data is output as “0”. When a pressure is applied to the pressure pad 531, an impedance value of the pressure pad 531 is increased to lengthen the delay time of the fourth signal sig4, thereby generating a difference between the delay times. The pressure data generating part 540 measures a difference between the delay times using a counter, and so on, and outputs pressure data pre_data.

In this process, the longer cycle of the reference signal ref_sig generated from the reference signal generating part 510 and the larger impedance value vary on the pressure pad 531, and the larger pressure can be measured.

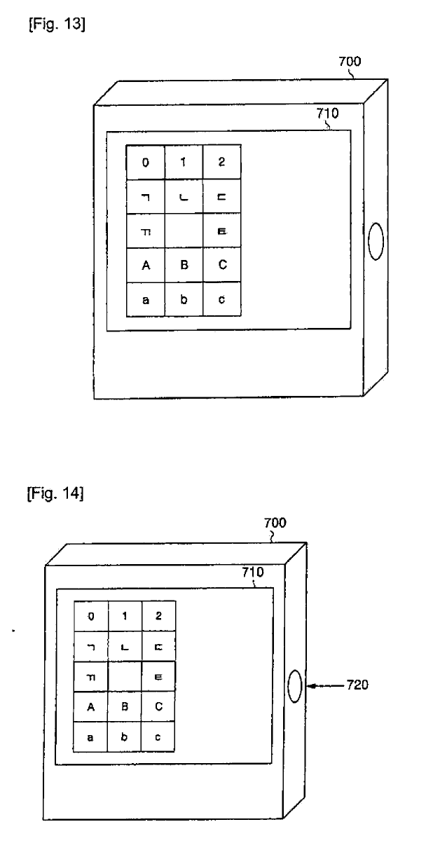

FIG. 12 is a view of an input device having a touch sensor and a pressure sensor in accordance with the present invention. The input device of FIG. 12 includes a third input line lineP and a pressure pad P_PAD, in addition to the input device of FIG. 5, in order to detect a pressure. The third input line lineP and the pressure pad P_PAD are connected to a fourth input line. In addition, an input signal determination part 600 further includes the pressure detection part 500 of FIG. 11, in addition to the touch detection part, to output pressure data P_data.

When the pressure sensor as shown in FIG. 12 is used, the pressure detection part 500 may be solely used in the input signal determination part 600, or may be used together with the touch detection part and the pressure detection part. In addition, since the decoding part shown in FIG. 8 simply divides logic signals into “high” and “low” to decode the logic signals, the pressure data P_data output from the pressure detection part 500 should be separately output, not applied to the decoding part.

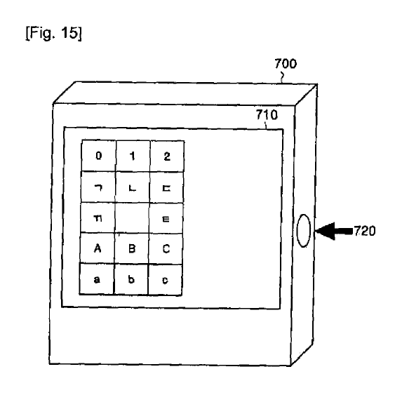

FIGS. 13, 14 and 15 are views of an input device for generating a large number of input signals through a small number of input lines using the pressure pad shown in FIG. 12.

While FIGS. 3A to 7 illustrate the input device for generating a large number of input signals through a small number of input lines using an electrical touch sensor, it is not likely to add a large number of input signals in an actual electronic appliance. This is because it is not likely to expand functions of each product more than a certain level. Therefore, in order to reduce a layout area on initial design, the input device for generating a large number of input signals through a small number of input lines in accordance with the present invention may be used, or two or three input lines among the input lines shown in FIG. 3B or 6 may be selectively used. However, with development of various mobile devices requiring numerous additional functions, a large number of input signals should be applied to a compact-sized mobile device. In particular, mobile devices such as a mobile phone or a PDA require numerous input signals such as numbers, Korean letters, Roman alphabet letters, and so on. Nowadays, inputting the characters is performed by selecting characters displayed on a touch screen or input keys on a front panel. In particular, when inputting the characters, a corresponding key is pushed repeatedly to convert the numbers, Korean letters, and Roman alphabet letters in a sequential manner, or a separate mode shift key is repeatedly pushed to convert the numbers, Korean letters, and Roman alphabet letters in a sequential manner. In addition, Korean letters should be divided into lax consonants and tense consonants, and Roman alphabet letters should be divided into uppercase and lowercase letters.

The input device for generating a large number of input signals through a small number of input lines shown in FIGS. 13, 14 and 15 includes a pressure sensor.

FIGS. 13, 14 and 15 illustrate a mobile device 700 further including the pressure sensor. The mobile device uses a touch screen 710. As shown in FIGS. 13, 14 and 15, a pressure pad 720 as a separate key is disposed at a position in which a finger for gripping the mobile device 700, rather than a keypad or the touch screen, is touched.

A user presses the pressure pad 720 with his/her finger to input a certain character. According to the pressure intensity, a character input mode corresponding to the current pressure is displayed on the touch screen as one of the numbers, Korean lax consonants, Korean tense consonant, Roman alphabet uppercase letters, and Roman alphabet lowercase letters, and the user can input a corresponding character by selecting the characters displayed on the touch screen 710.

FIG. 13 illustrates a number input mode when a pressure is not applied to the pressure pad 720. FIG. 14 illustrates a Korean tense consonant input mode when a second level of pressure is applied to the pressure pad 720. FIG. 15 illustrates a Roman lowercase letter input mode when a fourth level of pressure is applied to the pressure pad 720.

As described above, when the pressure sensor is used as auxiliary input means when a character is input, it is possible to generate a large number of input signals through a small number of input lines.

Therefore, when the method of using a touch sensor described with reference to FIGS. 3A to 7 and the method of using a pressure sensor described with reference to FIGS. 13, 14 and 15 are used in a combination manner, it is also possible to generate a large number of input signals through a small number of input lines.

### INDUSTRIAL APPLICABILITY

As can be seen from the foregoing, an input device in accordance with the present invention can generate 2ⁿ−1 input signals through n input lines using an electrical touch sensor having a single touch pad for detecting a contact. In addition, partially using a pressure sensor instead of the touch sensor, it is possible to generate a larger number of input signals. Further, it is advantageous to miniaturize an electronic appliance by reducing the number of input lines and a layout area in initial product design. Especially, even when a pre-designed electronic appliance requires an additional function, it is possible to additionally generate an input signal by minimizing modification of the layout.

While a few exemplary embodiments of the present invention have been shown and described, it will be appreciated by those skilled in the art that various changes may be made to these embodiments without departing from the spirit and scope of the invention as defined by the appended claims and their equivalents.

1. An input device comprising:
n first input lines;
m groups of n second input lines connected to the n first input lines in different manners, m being larger than n;
m input means having m groups of n touch means correspondingly connected to the m groups of n second input lines; and
an input signal determination part for decoding signals of the n first input lines to generate input signals.

2. The input device according to claim 1, wherein the input means comprises the m groups of n touch means, m and n satisfying the following relationship:
m≦2ⁿ−1.

3. The input device according to claim 2, wherein the second input lines are connected to the m groups of n touch means to connect the first input lines to the touch means corresponding to digits in which 1 of each of binary numbers from 1 to 2ⁿ−1 is disposed.

4. The input device according to claim 2, wherein the touch means of the input means are divided such that a user touches all of the n touch means when an input is received from the user, and the divided touch means are distributed.

5. The input device according to claim 2, wherein the input means has the touch means inserted into each other in an alternate manner such that a user touches all of the n touch means when an input is received from the user.

6. The input device according to claim 4, wherein the input means has the touch means having the same area.

7. The input device according to claim 2, wherein the input means has the m groups of two touch means such that a user readily touches all of the n touch means when an input is received from the user.

8. The input device according to claim 7, wherein the second input lines are connected to the m groups of two touch means to be connected to the n first input lines in different manners.

9. The input device according to claim 1, wherein the input signal determination part comprises:
n touch detection parts connected to the n first input lines, respectively, to detect whether a user applies an input to the input means; and
a decoding part for decoding touch signals output from the n touch detection parts to output a plurality of input signals.

10. The input device according to claim 9, wherein the touch detection part detects a change in capacitance caused by the touch object when a touch is generated at the touch means to output a touch signal.

11. An input device comprising:
n first input lines;
m groups of n second input lines connected to the n first input lines in different manners, wherein m is larger than n;
at least one third input line;
at least one fourth input lines connected to the at least one third input lines;
first input means having m groups of n touch means correspondingly connected to the m groups of n second input lines;
second input means having pressure means correspondingly connected to the at least one fourth input lines; and
an input signal determination part for decoding signals from the n first input lines to generate a first input signal and generating a second signal corresponding to the at least one third input lines.

12. The input device according to claim 11, wherein the second input means comprises at least one pressure means for varying impedance when a pressure is applied.

13. The input device according to claim 11, wherein the second input lines are connected to the m groups of n touch means to connect the first input lines to the touch means corresponding to digits in which 1 of each of binary numbers from 1 to 2ⁿ−1 is disposed.

14. The input device according to claim 11, wherein the input signal determination part comprises:
n touch detection parts connected to the n first input lines to detect whether a user applies an input to the input means, respectively;
at least one pressure detection part connected to the third input lines to detect whether a user applied an input to the pressure means; and
a decoding part for decoding touch signals output from the n touch detection parts to output a first input signal, and decoding pressure data output from the at least one pressure detection part to output a second input signal.

15. The input device according to claim 14, wherein the touch detection part detects a change in capacitance caused by a touch object when a contact is generated at the touch means.

16. The input device according to claim 14, wherein the pressure detection part detects a change in impedance generated when a pressure is applied to the at least one pressure means to output pressure data.

17. The input device according to claim 11, further comprising:
a controller for setting a mode in response to the first input signal to output a mode signal, and performing a predetermined operation designated according to the set mode when the second input signal is applied; and
a display part for displaying the current mode in response to the mode signal, and displaying an indication corresponding to the second input signal.

18. The input device according to claim 11, further comprising:
a controller for setting a mode in response to the first input signal to output a mode signal, and performing a predetermined operation according to the set mode when the second input signal is applied; and
a touch screen for displaying the current mode and an input key corresponding to the current mode in response to the mode signal, and generating an input signal to output the input signal to the controller when a user's input is received.

19. The input device according to claim 11, further comprising:
a controller for setting a mode in response to the second input signal to output a mode signal, and performing a predetermined operation designated according to the set mode when the first input signal is applied; and
a display part for displaying the current mode in response to the mode signal, and displaying an indication corresponding to the first input signal.

20. The input device according to claim 19, further comprising:
a controller for setting a mode in response to the second input signal to output a mode signal, and performing a predetermined operation according to the set mode when the first input signal is applied; and
a touch screen for displaying the current mode and an input key corresponding to the current mode in response to the mode signal, and generating an input signal to output the input signal to the controller when a user's input is received.

21. The input device according to claim 5, wherein the input means has the touch means having the same area.
